(19) United States
(12) Patent Application Publication
(10) Pub. No.: US 2002/0107014 A1
(43) Pub. Date: Aug. 8, 2002

(54) SYSTEM AND METHOD RELATING TO TELECOMMUNICATIONS

(76) Inventor: REDDY KOSURI, TYRESO (SE)

Correspondence Address: BURNS DOANE SWECKER & MATHIS L L P, POST OFFICE BOX 1404, ALEXANDRIA, VA, 22313-1404, US

(21) Appl. No.: 09/010,259

(22) Filed: Jan. 21, 1998

(30) Foreign Application Priority Data
Jan. 21, 1997 (SE) SE 9700152-3

(51) Int. Cl. H04Q 7/20

(52) U.S. Cl. 455/426; 455/461

(57) ABSTRACT

A system and a method respectively for controlling telecommunications subscriber units via PC. The system comprises a number of PCs, a number of telecommunications subscriber units and at least one exchange arrangement including switching functionality. The exchange arrangement comprises a mobility server including third party control means. To the mobility server a number of PCs are connected vid a local area network. The PCs communicate with the mobility server via a third party control interface and each PC comprises an application for screen based telephony services. This application use a first party control interface for a user communication and each PC comprises converting means for converting between first party control interface operations and third party control operations so that the user can use first party control based applications together with third party control means in the mobility server.

### BACKGROUND

The present invention relates to controlling of telecommunications, e.g. telecommunication subscriber units via personal computer. Particularly the invention relates to a system for controlling telecommunication subscriber units via PC. Still further the invention relates to methods for managing and controlling telecommunications units through a personal computer, connecting calls to and/or from a telecommunications unit via PC. Particularly the invention relates to giving cordless telephone users access to screen based telephony applications.

Screen based telephony applications as such are known for fixed telephones, e.g. PSTN (Public Switched Telecommunications Network) telephones. Two basic models for offering screen based telephony applications for PC users are known. The first model relates to first party call control based applications. First party control is a mechanism through which a user can manipulate the users own telephone. Then a number of PCs (first party clients) are connected to each other via a LAN network (local area network). The first party client PCs are each connected to a telephone. The connection can either be a so called phone-centric in which case a PC is connected to the phone which in turn is connected to a switching arrangement, e.g. a PABX (private automatic branch exchange) or the connection can be PC-centric in which case a telephone is connected to a PC which in turn is connected to the switching arrangement, i.e. the PABX. For the switching arrangement, or the PABX, for both the phone centric and the PC-centric solution the user appears to be directly connected to the phone. In the first party call control software model the PC client comprises a screen based telephony application, a first party control software and a serial port driver. Screen based telephony applications run on top of application programming interface (API) based first party control software and the PC communicates normally over the serial port.

The second model relates to third party call control based applications. Third party call control provides the possibility to access and use any telephone that is connected to the switching arrangement, e.g. a PABX. Third party call control can be said to be equivalent to operator control. A third part, i.e. neither the called nor the calling party, controls the call. The user has an indirect connection to the switching arrangement or the PABX. This indirect connection is often provided through a third party server and an application. According to this solution PCs, here third party clients, are connected via a LAN which also connects to a third party server which connects to the switching arrangement, e.g. the PABX to which the telecommunication units or the telephones are connected.

The third party server here acts as a gateway for the communication between the PABX and the screen based telephony application which resides on the client PC. A user has to log on to the third party server to identify the telephone that is assigned to the user. Information about that telephone/user is sent to the user application via the third party server. The third party server in turn communicates with the PABX. The third party call control software model is such that the PC client comprises the screen based telephony application, first party control software, server software and a LAN driver whereas the PC server comprises third party control software, a LAN driver and a switch driver or a PABX driver. The communication between the server software in the client and the third party server is often proprietary which is a drawback.

As can be seen, the known solutions are quite complicated and their flexibility is limited and restricts the user control. Furthermore an additional server is required. It is apparent from how the known solutions works that they also do not give the user sufficient freedom in controlling the telecommunications, services etc.

### SUMMARY

What is needed is therefore a system for controlling telecommunications subscriber units via PC which offers a user a high degree of flexibility. A system is also needed through which a first party control application can be used for controlling a subscriber telecommunications unit, e.g. a cordless. A system for PC controlling of telecommunications is also needed which is simple and which does not require additional equipment such as additional third party control servers etc. Particularly a system is needed through which screen based telephony applications can be offered to cordless users and giving them access the telephony services.

Therefore a system is provided which comprises a number of personal computers, a number of telecommunication subscriber units and at least one exchange arrangement with switching functionality. The exchange arrangement comprises a mobility server comprising third party control means and a number of personal computers are connected to said mobility server via a local area network, i.e. they are LAN-connected to said mobility server. The communication between the personal computers and the mobility server takes place over a third party control interface. The personal computers each comprise an application for screen based telephony services and this application uses a first party control interface for user communications. Each personal computer comprises converting means for converting between the first party control interface and the third party control interface so that the user can use the first party control based application with third party control means in the mobility server.

Advantageously the first and the third party control interfaces respectively are standard interfaces. The third party control software for a number of subscriber telecommunication units, e.g. cordless telephones, is provided in the mobility server and first party control software is provided in each of the personal computers.

The mobility server is an arrangement providing for protocol conversion among others and particularly provides cordless and cellular telephones with access to a private network or to a private branch exchange. Entire networks of mobility servers can also be provided. This is however not further discussed here even if the invention is applicable also to such embodiments. Mobility servers are for example described in the patent applications WO 96/21330 and WO 96/21329 both enjoying priority from U.S. patent applications 08/366,469 and 08/366,471 filed on Dec. 30, 1994 and which are incorporated herein by reference.

According to WO 96/21330 a mobility server is arranged between a PBX (PABX) and at least one radio exchange (REX) which in interworking with the PBX emulates a radio exchange thus providing cordless mobility between a number of REXs. The mobility server is arranged between a PBX and a number of REXs using the existing interface between them.

According to WO 96/21329 a mobility server is connected on an interface to an exchange and connects a cellular system to the mobility server directly or over e.g. a PBX so that a cellular telephone appears as an extension to the exchange thus providing cellular access to e.g. a PBX.

In one embodiment the mobility server is connected to a switching arrangement, for example a PABX. In an alternative embodiment the mobility server itself includes switching functionality.

Advantageously the local area network through which the PCs are connected to the mobility server is a LAN. To provide a screen based telephony application for a cordless user two connections are required, one to the personal computer and one to the cordless telephone as mentioned above.

Advantageously for the communication between the mobility server and the personal computer the CSTA protocol is used. CSTA means Computer Supported Communications Applications. Advantageously the ECMA (European Computer Manufactures Association) CSTA phase II protocol is used. Moreover, in one embodiment the first party control interface is a TAPI™ interface, Telephony Application Programming Interface.

Advantageously any first party control based application as well as any third party control based application can be controlled through any PC included in the system for any of the system telecommunication subscriber unit. Advantageously is also a system needed through which a user can not only connect, disconnect a call and receive a call using PC control but also control and manage the user service profile. This is enabled through use of a system as described above in which the mobility server has such an architecture that it comprises so called feature modules that can be introduced (are taken away) according the users personal licensing. Thus a user can via PC control the services he wants to have; it is possible to define a personal service profile. This is however a particularly advantageous embodiment which as such is not depending on the inventive features of the invention but which can be used in combination therewith.

Advantageously can a user, from any PC of the system, direct calls to/from cordless, fixed as well as cellular telephones. In a similar manner a user can advantageously define the service profile, as referred to above, this is not depending on the conversion between first party control interfaces and third party control interfaces per se.

Advantageously the converting means in the personal computer comprises an arrangement for translating first party call control interface commands to/from third party call control interface operations and coding means for encoding/decoding third party call control operations into/from the packets and a transmitter/receiver for sending/receiving packets over the LAN connections. Advantageously the first party control interface, e.g. TAPI, comprises a low level Telephony Service Provider Interface, TSPI and TSPI commands are translated into CSTA operations wherein the translating arrangement of the converting means collects function calls from the TSPI interface which are mapped into CSTA operations. In the encoding/decoding arrangement the CSTA operations are particularly coded by a coding algorithm into/from so called BER packets, Basic Encoding Rules which is an encoding standard for ASN.1, Abstract Syntax Notation One which is a data transfer syntax that e.g. may be used. Advantageously the communication of the mobility server through sending/receiving the packets is provided through a transmitter/receiver of the converting means which arranges BER packets in UDP, User Datagram Protocol, which is a connectionless protocol for communication over a LAN, and vice versa. The mobility server driver (the telephony service provider interface) which includes translating means, encoding/decoding means and transmitting/receiving means is responsible for login/logoff to the mobility server and the screen based telephony application is responsible for the remaining services.

Instead of the UDP may TCP (Transmission Control Protocol, used in Internet) be used. This is a connection oriented protocol in contrast to UDP which is connectionless and it is “safer”, e.g. giving information if a PC has gone down etc. However, it requires more power from the MOBS. This however, relate to alternative embodiments. There are advantages in using UDP as well as in using TCP.

According to the invention a method is also provided for connecting a call to a telecommunications unit which is connected to an exchange with the use of a personal computer comprising a screen based telephony application for controlling a number of telecommunication units. The method comprises the steps of

dedicating the PC for the telecommunication unit from which a call is to be performed, the identifications for a number of teleommunication units being stored in storing means e.g. of the PC, said storing means being connected to third party control means of a mobility server;

informing the third party control means in the mobility server connecting to an exchange or a mobility server itself including switching capability that a PC is dedicated for a given telecommunications unit;

informing the screen based telephony application in the PC about destination telecommunications unit to which a call is to be connected;

converting said destination information on a first party control interface into third party control interface operations in converting means in said PC;

transmitting the converted information to the third party control means;

interpreting in the third party control means in the mobility server said operations and controlling with the use of said operations the connection from the calling telecommunications unit to the called telecommunications unit via the switching functionality.

Advantageously a connected connection can be disconnected via PC thus comprising the steps of giving the screen based telephony application information that the connection is to be disconnected, transforming the information from the screen based telephony application to the first party control means in the personal computer, converting the first party control commands to a third party control operation in the converting means of the personal computer and disconnecting the connection via the third party control means. Alternatively a call can be disconnected through making off hook on e.g. the cordless telephone.

A method for connecting an incoming call to at least one first telecommunications unit from a second telecommunication unit wherein the first telecommunications unit may comprise one or more of a cordless telephone, a cellular telephone or a fixed telephone is also provided which comprises the steps of

detecting in third party control means in the mobility server an incoming call to said first telecommunications unit(s);

examining via the third party control means if for said first telecommunications unit(s) a cooperating PC is given including first party control means;

if yes, transmitting from the third party control means via a third party control interface information about a call to the first telecommunications unit from said secind telecommunications unit to converting means in the PC;

converting the third party control operation to a first party control operation;

informing the screen based telephony application about the call to the first telecommunications unit(s);

connecting the call.

Advantageously a user can also control via a cooperating or dedicated PC if a call is to be connected to the user's cordless telephone or a fixed telephone etc.

A method for managing and controlling a cordless telephone via PC comprising a screen based telepony application is also provided. The PC comprises a first party control interface. The PC is LAN-connected to a mobility server either connecting to e.g. a PABX or itself including switching functionality which mobility server comprises means for third party control. In the PC a conversion is done between first party control operations and third party control operations so that a user can use the first party control based application for third party control based means. It should however be noted that if third party control software is provided in the PC the conversion is of course not done. Advantageously a personal service profile can be defined in the mobility server for a user from the screen based telephony application part in the PC, on condition that the application supports such functionality.

It is an advantage that through the present invention a flexible system and a method respectively is provided enabling a user to in a simple way control outgoing as well as incoming calls. It is also an advantage that both first and third party control operations can be carried out from a PC with use of first party control means in the PC and in that no additional servers are required thus making the system simple and cheap and still providing for a much higher degree of flexibility than hitherto known systems.

### BRIEF DESCRIPTION OF THE DRAWINGS

The invention will in the following be further described in a non-limiting way with reference to the accompanying drawings in which:

FIG. 1 schematically shows a system according to the invention,

FIG. 2 schematically illustrates two personal computers with dedicated cordless telephones connecting to a mobility server including switching functionality,

FIG. 3 in a schematical way illustrates a software model for cordless call control according to the invention,

FIG. 4 schematically illustrates a PC which is LAN-connected to a mobility server according to one embodiment of the invention,

FIG. 5 shows an alternative embodiment of a mobility server connected to a PC,

FIG. 6 shows a mobility server including switching functionality which is LAN-connected to a PC and connected to a radio exchange arranged between a first and a second base station,

FIG. 7 is a schematical flow diagram relating to the connection of a call from a first subscriber to a second subscriber,

FIG. 8 is a simple flow diagram describing the handling of an incoming call, and

FIG. 9 shows an example of a mobility server comprising a number of feature modules.

### DETAILED DESCRIPTION

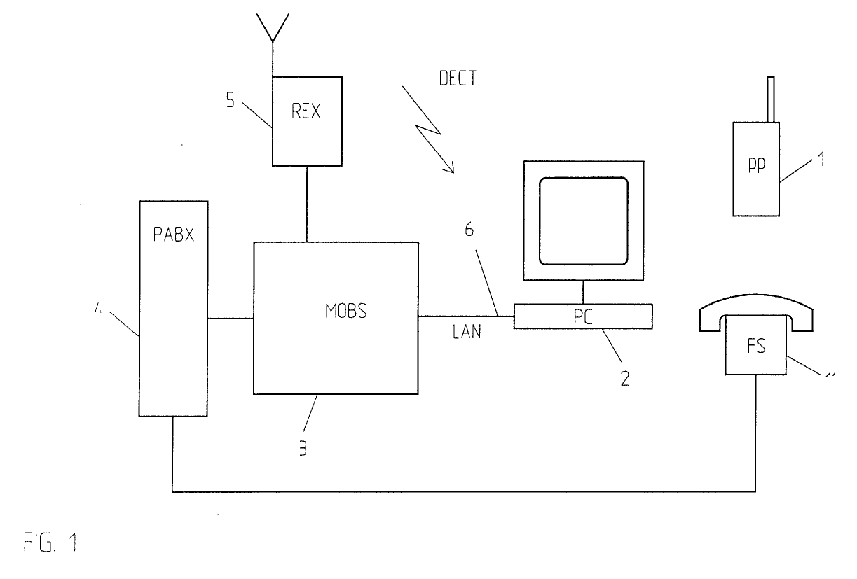

In FIG. 1 an embodiment is shown in which a user has two telecommunication subscriber units, namely a cordless telephone 1 (PP) and a fixed telephone 1′ (FS). With use of a personal computer 2 (PC) comprising a screen based telephony software application, a user can control the cordless telephone 1 as well as the fixed telephone 1′ e.g. for setting up calls to other telecommunication subscriber units and to receive calls.

The PC 2 is connected to a mobility server 3 e.g. via a LAN connection (Local Area Network). In the shown embodiment the mobility server connects to a radio exchange (REX) 5 and to an exchange 4. The screen based telephony application may have functions such as directory (catalogue) information, provide for handover possibility between a fixed telephone, a celullar and a cordless and advantageously also for the management of the personal profile. However this will be more thoroughly discussed later on.

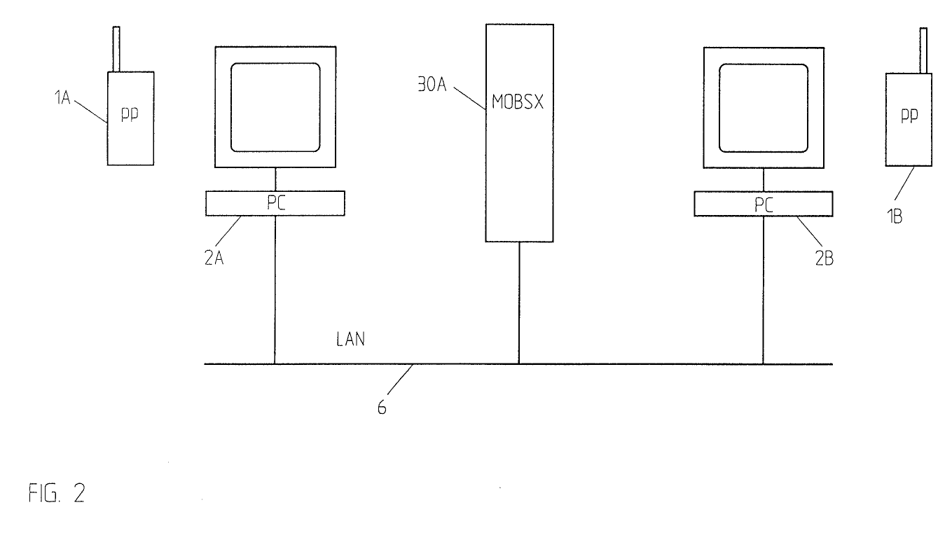

In FIG. 2 a system according to one embodiment is illustrated in which the mobility server (MOBSX) 30A includes switching functionality. Alternatively a mobility server may be connected to a switching arrangement. Two cordless client PCs 2A, 2B are connected through LAN 6 to the MOBSX 30A. Each cordless user has a cordless telephone 1A, 1B for which the respective PCs 2A, 2B are dedicated. Third party call control software is provided in the MOBSX 30A. Conversion between first and third party call control interfaces is done in the client PCs 2A and 2B respectively.

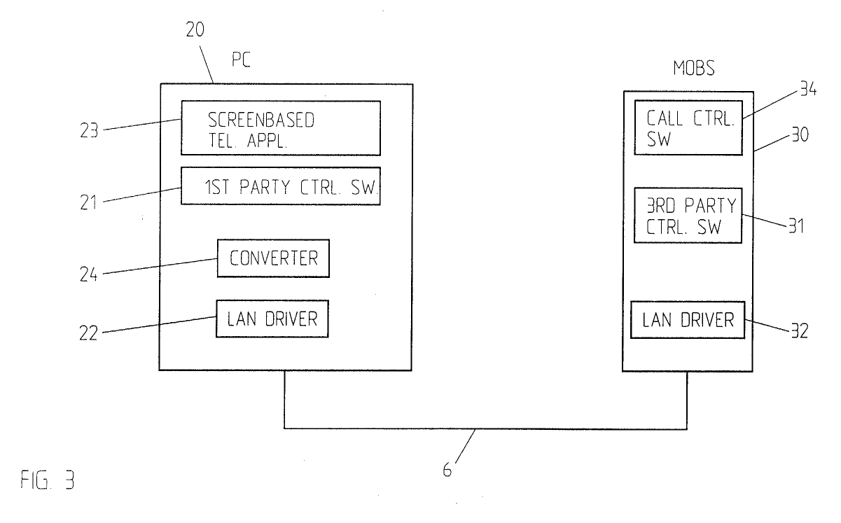

This is illustrated in FIG. 3 which is a software model for cordless call control. The client PC is here denoted 20. The PC 20 comprises a screen based telephony application SBTA 23. Furthermore it comprises first party call control software 21. Third party control software 31 is provided in the mobility server MOBS 30. The mobility server 30 furthermore comprises call control software 34 which however need not be further discussed herein since it may be conventional call control software. In the PC 20 converting means 24 are provided for converting between first party control operations/commands and third party control operations/commands. The PC 20 and the mobility server 30 are connected via a LAN 6 and each comprise a LAN driver 22, 32 respectively. Advantageously standard interfaces are used both for first party call control and for third party call control. That standard interfaces can be used is an advantage of the invention which makes it easy and attractive to implement. It is also an advantage of the invention that no extra PC server is required. The user can run any first party control based applications in the client PC 20 and any third party call control based application towards the PABX or the mobility server which as referred to above itself may include switching functionality or be connected to a PABX thus providing for the switching functionality. It should however be noted that although it is generally referred to a PABX, the invention is of course not limited thereto. Quite the opposite, PABX here relates to an exchange in general, private as well as public.

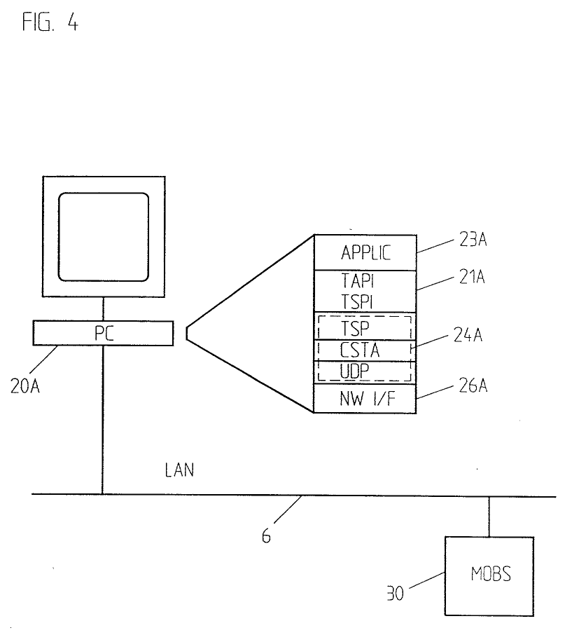

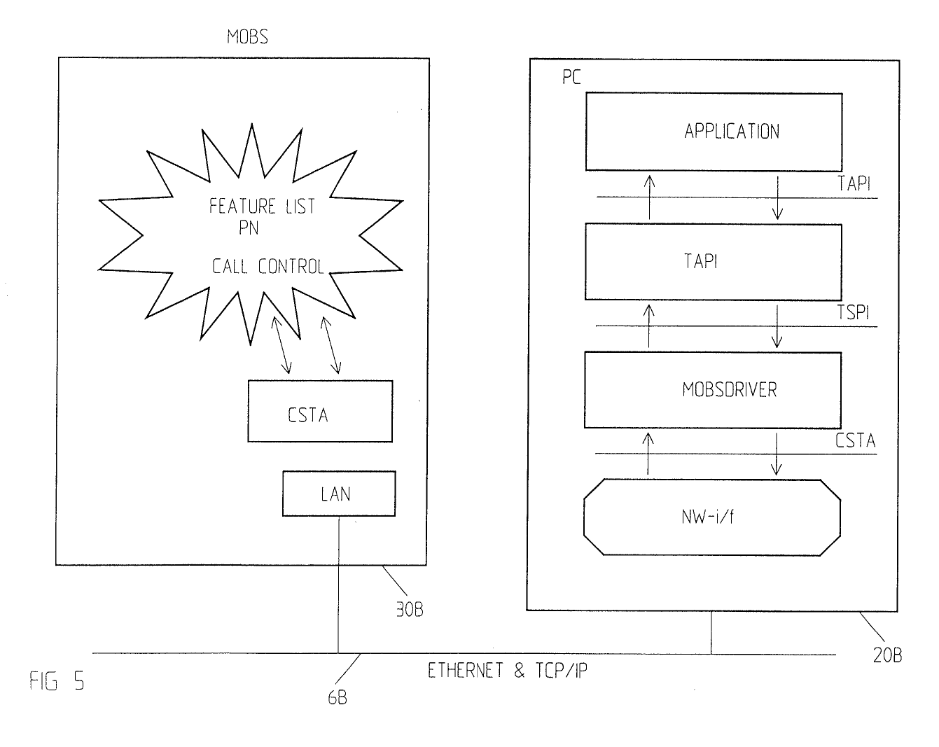

FIG. 5 shows a mobility server (MOBS) 30B connected via Ethernet & TCP/IP 6B to a PC 20B. In an advantageous embodiment the PC is e.g. a Windows 95 or a Windows 3.11 based PC by Microsoft™ which communicates with the MOBS 30B through the UDP/IP protocol which will be further described under reference to FIG. 4. In FIG. 5 however is TCP/IP (Transmission Connection Protocol/Internet Protocol) used instead. Advantageously, as already mentioned above, the protocol between the MOBS 30B and the screen based telephony application of the PC is based on the CSTA phase II (ECMA). In this particular embodiment the PC application supports personal number (PN) functionality towards a single mobility server configuration, i.e. MOBS 30B. Here personal number specific messages are available to the calling and the called users only if they belong to the one and the same mobility server. However, in alternative embodiments a configuration of networked mobility servers is used.

One example of a screen based telephony application is personal screen call (PSC) by Ericsson. Advantageously the application supports mobility server users only having a cordless telephone and mobility server users with a personal number. The mobility server here comprises a processor card with a LAN port e.g. intended to be used for management and the PC application communicates with the mobility server through that LAN port. (Other alternatives are of course possible.) The CSTA (Computer Supported Telecommunications Applications) protocol relates to one example of a mobility server third party control interface. It keeps control of A-number as well as B-number (A-number being the calling party number and B-number being the called party number as is well known in the art). This in contrast to the first party control (e.g. TAPI) of the PC which only notes A-number. The conversion between the protocols/interfaces is done in the PC converter of the MOBS-driver. The PC application is based, in this particular embodiment, on MS-Windows 95 or 3.11 and Windows Telephony Application Programming Interface TAPI. The application includes the TAPI application and the Telephony Service Provider Interface, in the following denoted TSPI driver. The TSPI, also denoted Mobility Server Driver, cooperates with third party software and also other TAPI applications. It should however be clear that the invention of course is not limited to use the protocols mentioned herein, they are just given for exemplifying reasons. Other protocols can of course also be used, protocols known in the art as well as other protocols e.g. developed for this particular purpose (or other purposes as well).

In an advantageous embodiment it is possible to have both PABX (for example Ericsson MD 110) and mobility server service providers (TSPI drivers) within the same PC and TAPI application. A user may have both a deskphone, a cellular telephone and cordless or personal number. In an advantageous embodiment a user may select one of the service providers for example for outgoing calls etc. if more than one service provider is used alternatively there is just one driver, the MOBS driver used to provide the access.

The user can pick-up an incoming call on any of the telecommunication subsriber units e.g. a cordless or a deskphone if an incoming call activates both (or more) terminals at the same time. This is for example a feature in the personal number service of the mobility server. The network interface is indicated NW-i/f.

A number of functions are implemented in the PC applications and they are supported via the MOBS. Some of these are e.g. the log-in procedure, Call logging, log-off, Personal Number (PN), Call Related actions, Basic call etc.

Returning now to FIG. 4 the implemention of a PC telephony service provider (the driver itself i.e. the MOBS driver 24A) for communication with the mobility server 30 will be more thoroughly described. As referred to above the PC 20 communicates with the mobility server 30 via LAN 6 using the ECMA CSTA phase II protocol 6. Advantageously the screen based telephony is the personal screen call, PSC, still more particularly including profile management 23A. TAPI and TSPI, which is the “low-level” interface of TAPI have already been described in the foregoing. They are here given the reference numeral 21A.

The driver 24A has its main task to translate TSPI commands from TAPI to CSTA operations, put them in the UDP packets (User Datagram Protocol is a connectionless protocol for communication over an Ethernet LAN), for output of said UDP packets to the network and vice versa for incoming messages. As discussed under reference to FIG. 5 TCP can alternatively be used. Furthermore the driver is responsible for the login/logoff procedures in the personal number services. The rest of the services are advantageously handled by the TAPI application. The driver can be said to comprise the converting means for the TSPI-CSTA translation (TSP), a CSTA codec and an UDP transmitter/receiver. Since an application uses TAPI for example to set up a call several functions call from the TSPI to the service provider will be done. Since not all these calls can be directly translated to CSTA operations the converting means for TSPI-CSTA translation handles the gathering of commands and translation. The converting means collects the function calls from TSPI and maps them to the appropriate CSTA operations. Then it calls functions in the CSTA codec and the UDP transmitter for further processing. Vice versa is done for incoming messages.

After the translation, the CSTA operations are coded into ROSE ASN.1 formats (Remote Operation Service Entity, Abstract Syntax Notation One which is a data transfer syntax) by the CSTA codec. The encoding algorithm that is used is in this particular embodiment the Basic Encoding Rules which is an encoding standard for ASN.1, in short denoted BER. The output packets are denoted BER packets. For incoming messages, the opposite operation takes place. The codec is only responsible for encoding/decoding. It should however be noted that ASN.1 is of course no requirement for the functioning of the present invention. Any appropriate standard can be used. E.g. may simpler or just different protocols be used.

The driver 24A communicates with the mobility server 30 through sending of datagram packets over LAN 6 according to the UDP standard. The UDP transmitter takes BER packets and puts them into UDP packets. If necessary, they are splitted. The opposite operation, from UDP packets into BER packets etc. takes place when the communication is the other way. The UDP transmitter is only responsible for the network transmission and UDP packet assembly/disassembly. In principle the driver 24A has to deal with three external interfaces, namely the TSPI (the “low-level” interface of TAPI), the network interface and an interface to the profile managing application if such is supported. The profile traffic then passes through TAPI by using extended services without TAPI interpreting it. All traffic between the application and the service provider however passes through TAPI.

The log-in in procedure is thus performed by the service provider, i.e. the mobility server driver of the PC application towards the mobility server. Through this procedure the PC application is identified and logically connected to the cordless terminal of the user in the mobility server. Users who do not have a personal number are assigned a password connected to the cordless number whereas users having a personal number use the password assigned to the personal number.

The mobility server indicates to the PC application whether a user has a personal number or not as already mentioned above. The screen based telephony application sends a query and receives information about the status of the extension from the mobility server in order to synchronize with the state of the cordless telephone/the personal number at that moment. If for example the user is still present in the mobility server from a previous session the user is logged out in order to guarantee that the user is connected to the mobility server trough one instance and one location only.

The so called Call log function is user or PC based. The log is connected to the PC of the user which means the PC where the application is started. If that PC is not active which means that if the PC has gone down without indicating the mobility server, then the call log information is not stored anywhere. Call related events such as incoming call to the extension and outgoing calls are sent to the PC application from the mobility server. Calls are logged even if they are not successful such as for example screened calls or if a temporary number is activated. In that case the cordless telephone is not alerted.

Incoming call data for a personal number user are logged in order to know where and if the call is answered. This information can be used to change the user profile either automatically or depending on user defined criteria. The call log information is stored locally in the PC.

Incoming/outgoing calls are logged according to PAS (Personal Screen Call) general principles. Incoming calls for the personal numbers are however logged differently. Unanswered, screen calls are logged as such whereas successful calls are logged depending on at which answering position they are answered which means for example answered by cellular telephone, cordless answered etc.

Logoff is done in three cases or under three circumstances. The first is if the PC application is terminated normally. Then the PC application sends a logoff message to the mobility server which then frees the resources and terminates the session towards the PC application. Furthermore every new login with the same user leads to a logoff of the previous session if such exists in the mobility server. There is only one PC application session with the same user identification. Still further the user is logged off automatically in case the mobility server does not receive a confirmation from the PC application during an incoming call procedure. It is then assumed that the PC is turn off. The logoff procedure is thus executed automatically when the driver terminates. The driver terminates as soon as the last TAPI application is closed. As referred to above the call log is the function for which the SBTA (Screen Based Telephony Application) is responsible. The driver is not involved in the actual logging but it sends progress reports to the SBTA. Logoff is thus performed by the TSPI.

As far as personal number functionality is concerned, the PC application is aware of the personal number user i.e. it is aware of whether the called party and/or the calling part has a personal number or not.

As far as call related actions are concerned, it is advantageously possible for a user to use either e.g. the cordless or the PC application or both while performing call related actions which means that the user can press off-hook on the cordless and then pick a number to call from the PC application.

The call set-up, incoming call and disconnect call services (also denoted basic call services) are interpreted by the driver and mapped from and to TSPI operations.

The basic call procedure relates to the making of an outgoing call and the receiving of incoming calls and the disconnection of calls.

A user can make a call with the use of the PC application. Then the cordless starts ringing at the calling user side first and the user has to set the cordless in off-hook position before the actual call is placed to the called party by the mobility server. outgoing calls shall be presented with called name, if such is available in the PC directory, and the called number to the user through the PC application. This information is logged in the call logging function i.e. locally in the PC.

Extended call progress information is provided by the mobility server if the called party has a personal number. This information is presented to the calling user through the PC application.

The PC application indicates an incoming call with the calling party number and the calling party name if it exists in the local PC directory. The user then has to pickup the call through the cordless. Since UDP/IP communication between a mobility server and a PC application over a LAN is connectionless, the mobility server checks if the PC application is active or not through the sending of so called inquiring messages. This is done together with an incoming call. The PC application then has to acknowledge the message and if there is no reporting back after a given period of time, the mobility server takes down the connection to the PC applications and the resources are released. This is also denoted a forced logoff. An incoming call is logged locally in the PC even if it is not successful.

A call can moreover be disconnected either from the cordless or through the PC application.

Furthermore a number of supplementary services are advantageously available. Advantageously supplementary services are implemented as CSTA services between the mobility server and the screen based telephony application. These services are known per se and therefore are they merely named herein. Some of them refer to call hold/retrieve, call transfer, conference, call forwarding, call completion (call back, intrude), call pickup etc. The incoming set of these services are translated by the driver to TSPI operations, these are in a particular embodiment specific to the particular PABX, for example Ericsson MD 110.

Advantageously are also other services available. For example the PC application is able to signal to the mobility server to send DTMF (Dual Tone Multi Frequency) tones during a call for example to a voice mail server or a personal assistant. Furthermore can advantageously an absence code or a message diversion be set from the PC application. Other services relate to diversion by-pass. Advantageously the PC application is able to send account codes, authorisation codes. Furthermore message waiting incication/cancellation is sent to the PC application and this information is presented to the user through the PC application. Another function relates to a caller's control. This is a function that is activated if the user can not be reached at one of the answering positions which are activated in a personal number. Then the calling party has a choice to act on given alternatives such as operator, assistant or voice mail.

Another functionality that is advantageously provided for and supported by the mobility server relates to defining of a personal profile for the user. This functionality as such does however not, as referred to above, depend on the protocol conversion as such. If the TAPI application supports management of the personal profile, are for example the following services sent through the driver to the profile part in the TAPI application: activate/deactivate profiles, enable/disable calls screening, ring time setting, password change for personal number and call screening by-pass, voice prompt style. If the user is a personal number subscriber, the driver will receive progress reports for incoming calls from the mobility server. The driver communicates with the profile management part in SBTA through TAPI using the extended services. Particularly all traffic concerning the profiles flows here. The profile managing functionality is partly in the application and partly in the service provider. The service provider handles login and logoff whereas the rest resides in the application.

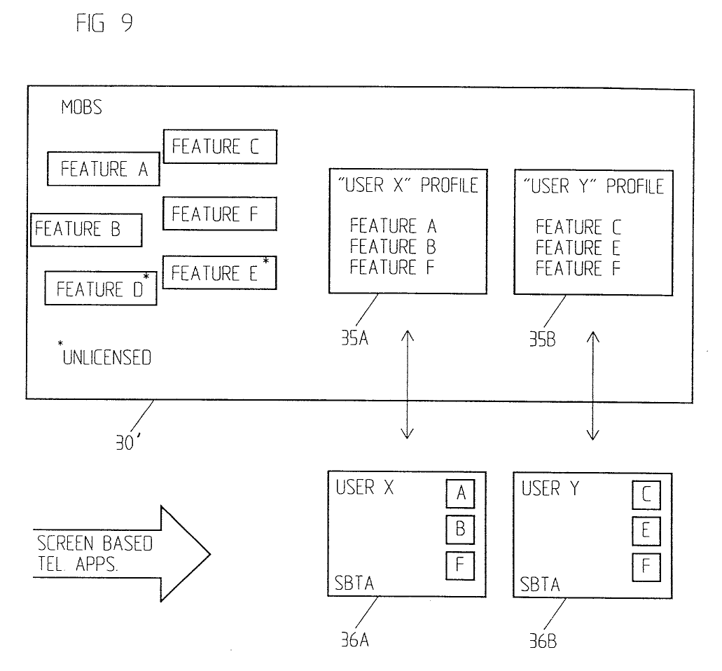

The management of a personal profile will however be further discussed under reference to FIG. 9.

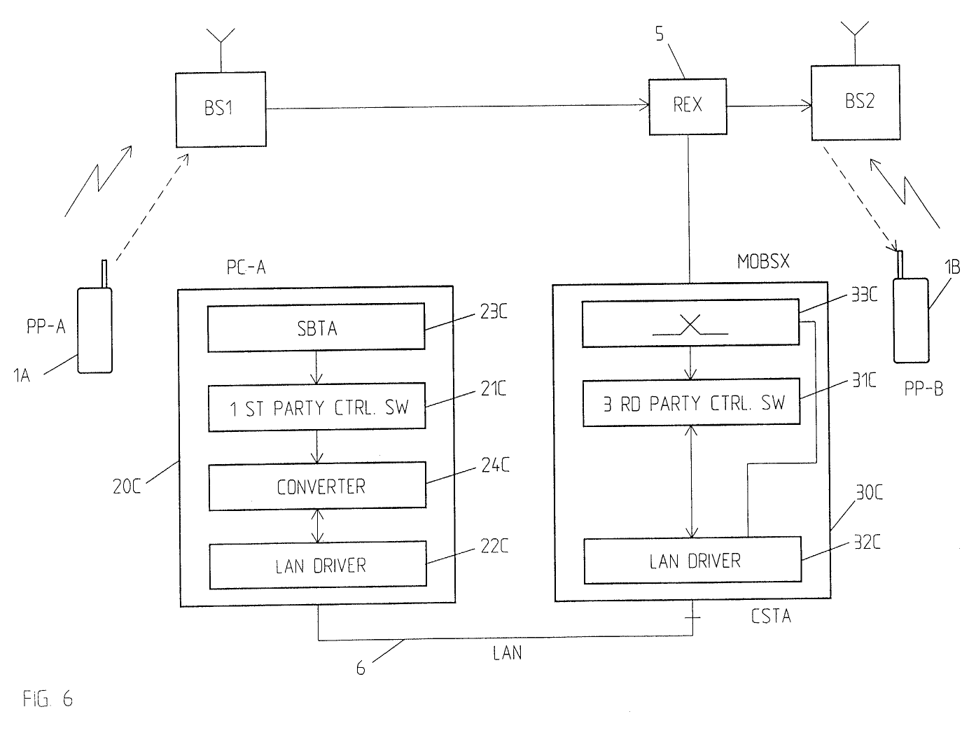

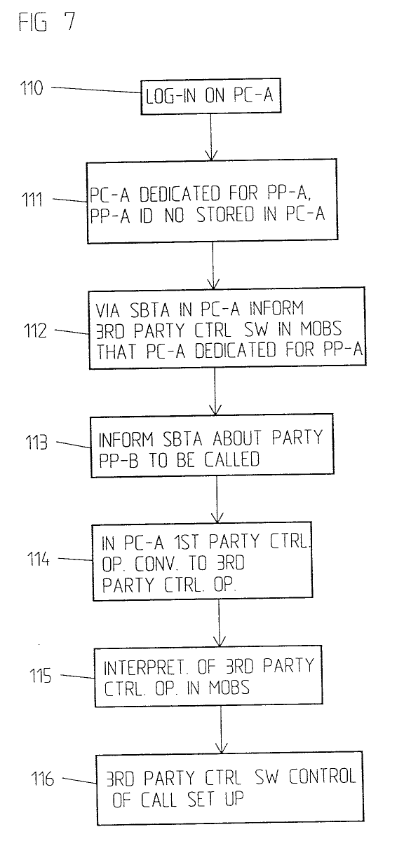

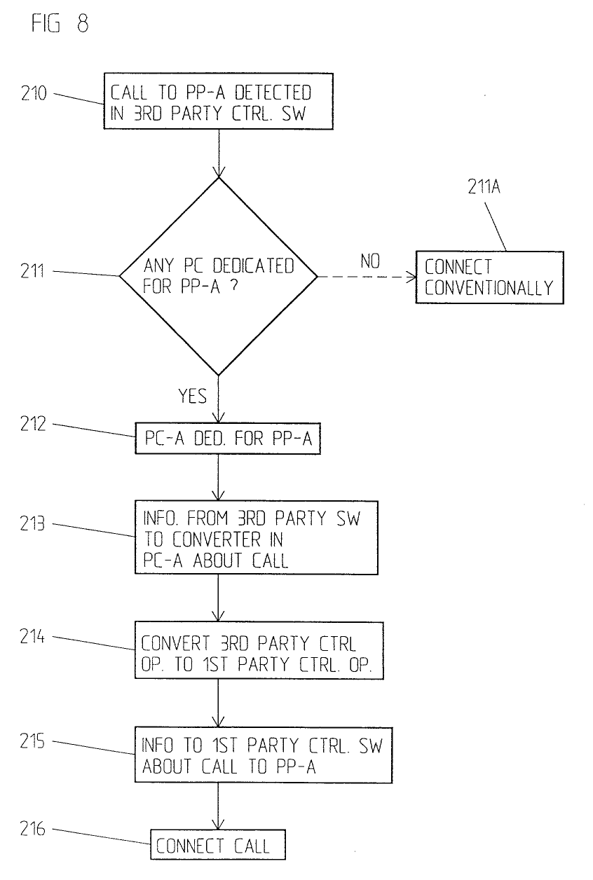

Under reference to FIG. 6 connection of a call made by a subscriber A having a cordless telephone PP-A 1A to another subscriber B using a cordless telephone PP-B 1B using a personal computer will be described. A simplified flow diagram relating to connecting a call from a subscriber A to a subscriber B is illustrated in FIG. 7. Correspondingly a simplified flow diagram is shown in FIG. 8 relating to the receiving of a call.

In FIG. 6 a personal computer PC A 20C is via LAN 6 connected to a mobility server 30C. In this embodiment the MOBSX 30C comprises switching means 33C which means that the connection is done in the MOBSX. Alternatively, as also discussed above the switching functionality can be provided externally of the mobility server. As discussed for example under reference to FIG. 3 the MOBS 30 also includes third party control software 31C and a LAN driver 32C. The PC 20C includes a screen based telephony application SBTA 23C, first party control software 21C, a converter 24C (c.f. FIG. 4 or the MOBS driver of FIG. 5) and a LAN driver 22C. The mobility server 30C is connected to radio exchange 5 in connection with base stations BS1 and BS2. PP A and PP B are cordless telephones 1A, 1B of a first user A and a second user B respectively. SBTA 23C is the software application that the user A uses for controlling cordless 1A. With the use of SBTA calls can be connected without keying on the cordless terminal 1A. Through the application it is also possible to log incoming calls etc. as discussed above. The first party control software 21C controls the cordless for which PC A 20C is dedicated. It is also used to keep all information about subscriber A's call in storing means (not shown) . For example information can be stored about received calls, connected calls, call attempts etc. The converting means 24C comprises the software for communication with the third party control software 31C in MOBS 30C. The third party control software 31C among others controls the call connection from a cordless when the SBTA is used. It is also used for detection of incoming calls to subscriber A and it is therefore connected to the switching means 33C in MOBS 30C. If the switching functionality is however not included in MOBS, the third party control software 31C is connected to switching means arranged externally of the MOBS.

The functioning was more thoroughly described under reference to FIG. 4 and 5.

A call from subscriber A to subscriber B will be schematically explained in the flow diagram of FIG. 7. It is supposed that subscriber A first logs in on his/her PC. Advantageously this is done through indicating to the PC that it is to be dedicated for a particular cordless telephone. In an advantageous embodiment this can be done automatically if the user always uses a particular PC (the user proprietary PC) to be dedicated for the cordless telephone PB-A. PB-A's, or subscriber A's number to a cordless telephone is then stored in memory means of the PC connected to the third party control software. Thus, 111, PC-A is dedicated for PP-A and the number is stored in the storing means connected to the third party control software.

Via the first party control software 21C the third party control software 31C in MOBS 30C is given information that PC-A is connected to cordless PP-A, 112. Via the screen based telephony application 23C information is provided that a call is to be connected to subscriber B, PP-B, 113. In the converting means 24C the first party control operation is converted into a third party control operation as described under reference to FIG. 4 and the third party control software 31C is thus provided with information that a call is to be set up from the cordless telephone 1A of subscriber A to the cordless telephone 1B of user B, 114.

Then the third party control operations are interpreted in the mobility server 30C, 115. Using the switching functionality 33C the third party control software 31C controls the connection of the call from subscriber A to subscriber B or cordless 1B, 116.

Disconnection of a call can, as referred to in the foregoing, either be done via the screen based telephony application or through making off-hook on the cordless terminal. Information about the disconnected call is stored in storing means connected to the third party control software.

FIG. 8 very schematically gives the flow when a call is incoming to subscriber A. In the third party control software 31C an incoming call to subscriber A is detected, 210. Then the third party control software 31C examines if any PC comprising a screen based telephony application is dedicated for subscriber A, 211. If there is no PC with SBTA dedicated for PP-A, the call connection proceeds in a conventional manner 211A, which will not be further described here.

If however it is established that a PC (here PC-A) with SBTA is dedicated for PP-A, 211, the third party control software 31C provides the converting means 24C in the PC-A via a third party control operation on a third party control interface that there is a call to PP-A, 213. In the converter 24C a third party control operation is converted to a first party control operation, 214. The first party control software 21C is then informed about a call to PP-A, 215. The call is then connected, 216.

As referred to above a mobility server may in one embodiment support a number of functions, relating to a “personal profile” for a user. If the SBTA supports such services, they are here sent through the driver to a profile part in the first party control application SBTA.

Call forwarding is one such functionality. In an advantageous embodiment a user with a personal number chooses one of a number of pre-defined profiles which is to be activated. Examples thereon are an in-office profile, an out-of-proffice profile, a temporary number profile and an absent profile. Only one of these profiles is active at a time. The in-office and out-of-office profiles respectively are “static” and pre-defined profiles existing in the mobility server. Temporary number provides the user with the possibility of assigning a temporary “call forwarding” numbers. Another service relates to activate/deactivate telephones. This function allows a user to do so on the set of telephones that are available in the chosen profile (in-office, out-of-office).

Another function is the call screening function. It can be used together with the call forwarding function which means that any call forwarding profile can be active at the same time as any of the screening profiles such as all calls (allowed), selected calls (allowed) and no calls (allowed). If the selected calls profile is selected then a list of selected telephones is activated. The list can be defined through the function “specify selected calls” which comprises the alternatives change call type (all internal, all external or selected list) or edit selection list. The call screening function can be overridden through a password; then the active call forwarding profile will be applied. Through the “change password to personal number” user can change the password that is assigned a personal number. Through another functionality it is possible to change the guiding voice prompts of personal number management to be long or short. Thus various profiles and functions can be activated/deactivated; enabled or disabled.

All events concerning the user are reported to the screen based telephony application which means the events concerning call related activites and changes concerning a personal number. A number of functions are implemented both in the mobility server and the screen based telephony application according to an advantageous embodiment. Examples on these functions are activate/deactivate the current forward profile which is done through choosing a profile in a list of pre-defined profiles.

Another function relates to enable/disable call screening functionality. This is done through the choice of a screening profile. Furthermore the ringtime to different answering telephones can be set individually. Thus a desired set of profiles can be set to be active in the mobility server e.g. call forwarding, call screening and caller's control.

Moreover a function relating to a change in the password connected to the personal number/user-id. Users who do not have a personal number are assigned the password connected to their cordless number.

The password can be changed to by-pass the call screening functionality and the changing voice prompt style from long to short or vice versa.

In an advantageous embodiment, depending on what the screen based telephony application supports, the following functions are implemented locally in the SBTA; create, maintain and delete call forwarding profiles, create, maintain and delete selected call screening profiles and create, maintain and delete multiple caller's control profiles.

The user profile can be customized in an easy way and a screen based telephony is shown which is adaptable to the user's personal profile which means that only the services that a user wants to have or in his own “personal telephone”.

The feature implementation of a mobility server 30 is illustrated in FIG. 9. The mobility server comprises a number of feature modules, wherein feature modules relating to a feature A, . . . , feature F are illustrated. In the figure the profile of the user X, 35A and of the user Y, 35B are illustrated. Via the screen based telephony application the user can licence features. With a screen based telephony application supporting such functionality a user can e.g. licence new features in the mobility server 30.

Thus the services depend on the licensing. If a service is licensed, it is activated and automatically loaded down from the MOBS to the application.

It should be clear that the invention is not limited to the illustrated embodiments but that it can be varied in a numbers of ways. Particularly the invention is not limited to the service profile management; this merely relates to a particularly advantageous embodiment.

Still further, the invention is not limited to the use of any particular exchanges or PABXS, any particular protocols or interfaces etc. but any appropriate protocols can be used as well as any appropriate PC, e.g. Macintosh™, and any appropriate screen based telephony application.

What is claimed is:

1. A system for controlling telecommunication subscriber units via PC, comprising a number of PC:s, a number of telecommunication subscriber units and at least one exchange arrangement including switching functionality, the exchange arrangement further including a mobility server comprising third party control means to which a number of PC:s are connected via a Local Area Network (LAN), wherein the PC:s communicate with the mobility server via a third party control interface, each PC comprising an application for screen based telephony services, which applications use a first party control interface for user communication, each PC further compriing converting means for converting between said first party control interface and said third party control interface, so that a user can use first party control based applications together with third party control means in the mobility server.

2. The system of claim 1,
wherein the first and the third party control interfaces are standard interfaces.

3. The system of claim 1,
wherein third party control means comprising software for a number of subscriber telecommunication units is provided in the mobility server, first party control means being provided in each respective PC.

4. The system of claim 1,
the Local Area Network e.g. is the Ethernet LAN.

5. The system of claim 3,
wherein for the communication between the mobility server and a PC a CSTA protocol is used.

6. The system of claim 5,
wherein the first party call control interface is a TAPI interface.

7. The system of claim 1,
wherein any first party control based application and any third party control based application towards the exchange via the mobility server is controllable from any of the PC:s and for any telecommunications subscriber unit.

8. The system according of claim 1,
wherein the switching functionality is provided in an exchange to which the mobility server is connected.

9. The system according of claim 8,
wherein the exchange is a PABX which via a radio exchange connects to a radio base station.

10. The system of claim 1,
wherein the exchange arrangement comprises a mobility server with switching functionality.

11. The system of claim 10,
wherein the mobility server with switching functionality comprises a PABX.

12. The system of claim 1,
wherein the mobility server comprises a number of service features implemented in modules.

13. The system of claim 12,
wherein the desired service features provided in the mobility server can be defined/licensed by the user via a PC, to define a user specific service profile.

14. The system of claim 1,
wherien the telecommunication subscriber units comprise cordless telephones.

15. The system according of claim 1,
wherein from any PC of the system, a user can direct calls to/from cordless, fixed as well as cellular telephones connected to the exchange.

16. The system of claim 15,
wherein from any PC of the system, a user can define a service profile.

17. The system of any one of the preceding claims,
wherein the converting means comprises an arrangement for translating first party call control interface operations to/from third party call control interface operations, coding means for encoding/decoding third party call control operations into/from packets and a transmitter/receiver for sending/receiving packets over the LAN connection.

18. The system of claim 17,
wherein the first party call control interface is a TAPI with a low level Telephony Service Provider Interface (TSPI) and in that TSPI commands are translated to CSTA operations, the translating arrangement collecting function calls from TSPI, and in that they are mapped into CSTA operations.

19. The system of claim 18,
wherein in the encoding/decoding arrangement the CSTA operations are coded by a coding algorithm into/from BER packets, and in that the communication with the mobility server through sending the packets is provided through the transmitter which arranges BER packets in UDP (TCP) packets and vice versa.

20. The system of any one of claims 17-19,
wherein the driver or converting means including translating means, encoding/decoding means and transmitting means is responsible for login/logoff in the personal number services, the TAPI application being responsible for remaining services.

21. A method for connecting a call to a telecommunications unit connecting to an exchange using a PC comprising a screen based telephony application for controlling a number of telecommunications units,
wherein the method comprising the steps of:
dedicating the PC for the telecommunications unit from which a call is to be performed, the identifications for a number of telecommunications units being stored in storing means e.g. in the PC, said storing means being connected to third party control means in the mobility server;
informing third party control means in the mobility server connecting to an exchange or itself including switching capability that the PC is dedicated for a given telecommunications unit;
informing the screen based telephony application in the PC about destination telecommunications unit to which a call is to be connected;
converting said destination information on a first party control interface (TAPI) into third party control interface (CSTA) operations in converting means in said PC;
transmitting the converted information to the third party control means;
interpreting in the third party control means in the mobility server said operations, and
controlling, using said operations, the connection from the calling telecommunications unit to the called telecommunications unit via the switching function.

22. The method of claim 21,
wherein the step of converting information includes the steps of:
translating first party control interface commands to third party control interface operations;
coding third party control operations into packets,
and the step of transmitting information comprises the steps of:
rearranging said packets into a formate appropriate for sending, e.g. UDP or TCP;
sending the rearranged packets over a LAN-connection to third party control means in the mobility server.

23. The method of claim 21 or 22,
wherein for disconnecting a call it comprises the step of making off hook on the originating telecommunications unit.

24. The method of claim 21,
wherein for disconnecting a connection it comprises the steps of:
giving the screenbased telephony application the information that a connection is to be disconnected;
transforming said information from the screen based telephony application to the first party control means in the PC;
converting the first party control command to a third party control operation in the converting means;
disconnecting the connection via the third party control means.

25. A method for connecting an incoming call to at least a first telecommunications subscriber unit from a second telecommunications unit, such as a cordless telephone, a mobile cellular telephone or a fixed telephone connecting to an exchange connecting to a mobility server, comprising the steps of:
detecting in third party control means in the mobility server an incoming call to said first telecommunications unit;
examining via the third party control means if for said first telecommunications unit a cooperating PC is given including first party control means;
if yes, transmitting from the third party control means via a third party control interface information about a call to the first telecommunications unit from said second telecommunications unit to converting means in the PC;
converting in the converting means the third party control operation to a first party control operation;
informing the screen based telephony application about the call to the first telecommunications unit;
connecting the call.

26. A method for connecting an incoming call to at least a first telecommunications subscriber unit from a second telecommunications unit, such as a cordless telephone, a mobile cellular telephone or a fixed telephone connecting to an exchange comprising a mobility server, comprising the steps of:
detecting in third party control means in the mobility server an incoming call to said first telecommunications unit;
examining via the third party control means if for said first telecommunications unit a cooperating PC is given including first party control means;
if yes, transmitting from the third party control means via a third party control interface information about a call to the first telecommunications unit from said second telecommunications unit to converting means in the PC;
converting in the converting means the third party control operation to a first party control operation;
informing the screen based telephony application about the call to the first telecommunications unit;
connecting the call.

27. The method of claim 25 or 26,
wherein the first telecommunications unit is a cordless telephone.

28. A method for managing and controlling telecommunications units such as one or more of a cordless telephone, a cellular telephone and a fixed telephone through a PC comprising a screen based telephony application and means for first party control comprising the steps of:
connecting said PC via a LAN to a mobility server comprising switching functionality, said mobility server comprising means for third party control;
converting in said PC between first party control operations on a first party control interface and third party control operations on a third party control interface, so that a user can use the first party control based application together with third party control means in the mobility server.

29. A method for managing and controlling telecommunications units such as one or more of a cordless telephone, a cellular telephone and a fixed telephone through a PC comprising a screen based telephony application and means for first party control comprising the steps of:
connecting said PC via a LAN to a mobility server connecting to an exchange with switching functionality, said mobility server comprising means for third party control;
converting in said PC between first party control operations on a first party control interface and third party control operations on a third party control interface, so that a user can use the first party control based application together with third party control means in the mobility server.

30. The method of claim 28 or 29, wherein the mobility server comprises a number of modules comprising service features, and further comprising the step of:
defining a personal service profile in the mobility server for a user through licensing the desired features from said screen based telephony application part in the PC.
